(19) United States
(12) Patent Application Publication
(10) Pub. No.: US 2009/0177874 A1
(43) Pub. Date: Jul. 9, 2009

(54) Processor apparatus and conditional branch processing method

(75) Inventor: Masaru Terashima, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/318,726

(22) Filed: Jan. 7, 2009

(30) Foreign Application Priority Data
Jan. 9, 2008 (JP) 2008-002344

(51) Int. Cl. G06F 9/30

(52) U.S. Cl. 712/234; 712/E09.016

(57) ABSTRACT

Disclosed is a processor apparatus including a branch condition storage unit having a plurality of storage regions in each of which a branch condition set by a condition setting instruction is stored, an instruction decoder that decodes an instruction code, an instruction memory that stores therein the instruction code, an operation register used by a processor for operation, a branch condition comparison unit that performs a comparison operation for each of branch conditions, a conditional branch determination unit that makes a determination whether or not to perform program branching in a conditional branch instruction, a selector that makes selection between a branch destination address and a next instruction address, based on an output value of the condition branch determination unit, and a program counter that indicates a processor instruction executing position. The branch condition specified by the condition setting instruction is stored in one of the storage regions in the branch condition storage unit 1 specified by the condition setting instruction. When the conditional branch instruction is executed, individual determinations on a plurality of the branch conditions stored in the branch condition storage unit are made. Among the branch conditions that simultaneously hold, the branch address corresponding to the branch condition stored in a predetermined one of the storage regions in the branch condition storage unit is selected from the branch address storage unit, and branching to the branch address is performed.

### REFERENCE TO RELATED APPLICATION

This application is based upon and claims the benefit of the priority of Japanese patent application No. 2008-002344, filed on Jan. 9, 2008, the disclosure of which is incorporated herein in its entirety by reference thereto.

### TECHNICAL FIELD

The present invention relates to a processor apparatus and a conditional branch processing method.

### BACKGROUND

With respect to a conditional branch instruction used in common general-purpose CPUs and the like, as schematically shown in FIG. 10, an instruction for performing an operation based on which a determination on a branch condition is made (such as a condition A determination instruction at an address N) is executed before execution of the conditional branch instruction. When the branch condition holds based on a result of the operation of the instruction (condition A determination instruction), branching to a branch destination address (such as a branch destination L1) specified by the operand of the conditional branch instruction is performed. When the branch condition does not hold, the procedure proceeds to the instruction at the next address (such as a condition B determination instruction at an address N+2 in the case of FIG. 10).

As shown in FIG. 10 as an example, in case four branch conditions are processed, one of instructions for condition determination (condition A determination instruction at an address N, condition B determination instruction at an address N+2, a condition C determination instruction at an address N+4, and a condition D determination instruction at an address N+6) and a corresponding one of conditional branch instructions (at addresses N+1, N+3, N+5, and N+7) form one set. Processing of four pairs of instruction executions is then consecutively performed. As a result, the time and an instruction storage region for execution of 8 steps are needed.

As a related art of conditional branching, the conditional branching described in Patent Document 1 will be described. FIG. 11 is a diagram showing a configuration of a processor disclosed in Patent Document 1. Referring to FIG. 11, information on true/false of condition 429, which is an output of a condition determination circuit 402 that receives an operation result 422 output from an operator 401 and a branch condition 431, is stored in one of condition establishment/nonestablishment registers 403 to 406 selected according to a condition establishment/nonestablishment register selection signal 424. When multi-branch processing is performed, information on true/false of condition is respectively written into the condition establishment/nonestablishment registers that are different to one another, according to a plurality of conditions to be processed, in advance. Branch addresses corresponding to branch conditions, respectively, are stored in branch destination address registers 408 to 411. When a multi-branch instruction is executed, a prioritizer 407 receives values of the condition establishment/nonestablishment registers 403 and 406 and generates a branch destination address selection signal 427, thereby controlling a selector 412. The selector 412 selects one of the branch destination address registers 408 to 411, thereby obtaining the value of a program counter 413. Branch processing is thereby executed.

Patent Document 2 discloses a configuration including branch instruction determination means, branch destination storage means, branch condition determination means, and branch destination selection means. The branch instruction determination means determines whether or not an instruction using an instruction code is a branch condition. The branch destination storage means stores therein a plurality of branch destination addresses. Branch condition determination means determines whether or not all of a plurality of branch conditions are satisfied. The branch destination selection means selects one branch address corresponding to one of the branch conditions determined to be satisfied by the branch condition determination means from among the branch destination addresses stored in the branch destination storage means. The conditional branching in this case is performed using one conditional branch instruction, based on an operation result of the instruction executed immediately before the conditional branching. Thus, the time and an instruction storage region for executing two steps are substantially needed.

Patent Document 3 discloses a processor (digital signal processor) in which one of outputs of an arithmetic calculator, a logical shifter, and a multiplier is selected in parallel with an operation of a calculation unit. Selected data is simultaneously compared with preset n threshold values, and it is determined that in which region among (n+1) data regions segmented by the n threshold values the output data exists. The resultant region in which the data is determined to exist is sequentially compared with m region limiting conditions specifying predetermined data regions. When coincidence is found in a region limiting condition, a branch destination address corresponding to the region limiting condition is output from among m branch destination addresses corresponding to the m region limiting conditions. A program counter is updated to the branch destination address. When incoincidence is found in all of the m conditions, a signal representative of incoincidence of the m conditions is output, and the program counter is incremented by one. When performing processing for which condition determination of each operation result is needed, a condition determination instruction does not need to be executed for each operation. Thus, processing can be performed at high speed.

Patent Document 4 discloses a data processing system that executes a program having an instruction sequence including a plurality of instructions of an ordered sequence. The ordered sequence includes its beginning and a plurality of branch instructions. When a condition specified by each of the branch instructions is satisfied, an instruction specified by the branch destination address of the branch instruction is executed. The data processing system includes storage means for specifying a plurality of the branch instructions, and storing therein information including the branch destination address corresponding to each of the plurality of the branch instructions and a relative position from the beginning of the ordered sequence of the plurality of the branch instructions; comparison result means for receiving information indicating that the condition related to one of the plurality of the branch conditions has been satisfied; means for receiving a branch execution instruction for identifying one of the plurality of the branch instructions having the information stored in the storage means; and control means for receiving the branch execution instruction when the condition related to the identified branch instruction is satisfied and the condition related to a branch instruction closer to the beginning of the ordered sequence than the identified branch condition is not satisfied, for response, and causing the data processing system to execute the instruction specified by the branch destination address corresponding to the identified branch instruction.

### [Patent Document 1]

JP Patent Kokai Publication No. JP-A-9-282160

### [Patent Document 2]

JP Patent Kokai Publication No. JP-P-2004-118669A

### [Patent Document 3]

JP Patent Kokai Publication No. A-2-187824

### [Patent Document 4]

JP Patent Kokai Publication No. JP-A-8-106386

### SUMMARY

The following analyses of the related arts are given by the present invention.

In the invention described in Patent Document 1, after individual branch condition determination instructions at the addresses N to N+3 (condition A determination instruction, condition B determination instruction, condition C determination instruction, and condition D determination instruction) have been executed four times, conditional branching can be processed using one multi-branch instruction (at an address N+4). Thus, the time and an instruction storage region for execution of 5 steps are only needed. High-speed processing and instruction storage region reduction are thereby implemented.

However, as shown in FIG. 12, it is necessary to execute conditional branch determination instructions the number of times necessary for making branch determination immediately before execution of the multi-branch instruction. For this reason, in loop processing where the same branch condition is repeatedly executed, it is necessary to execute conditional branch determination instructions.

In the invention described in Patent Document 2, a branch determination is made based on the operation result immediately before the branch instruction, as in Patent Document 1. Further, only the operation result of one instruction immediately before the branch instruction is given. Accordingly, compared with Patent Document 1 and the like, only a very simple branch condition can be accommodated. When the value of a branch destination address is to be increased, the instruction length of the conditional branch instruction is increased due to inclusion of a plurality of branch destination addresses. This shows that the instruction length extends over 2 words of an instruction memory. In this case, a step for reading a value in the second word into an instruction decoder is generated. Thus, generally, the number of instruction execution cycles is correspondingly increased.

In Patent Document 3, a plurality of branch destination addresses are stored in advance, and condition determination processing is performed simultaneously with calculation processing. That is, as shown in FIG. 13, a conditional branch instruction is also included in a calculation instruction (calculation+condition determination are instructed). When a condition holds based on a calculation result, branching to the branch destination address corresponding to the condition is performed. This means that the condition determination is made with the result of the calculation instruction used for comparison. Thus, only a simple branch condition can be set.

The present invention, which seeks to solve one or more of the above problems, is generally configured as follows.

According to one aspect (aspect) of the present invention, there is provided a processor apparatus including:

an instruction set that includes a condition setting instruction which specifies a branch condition and a priority order of the branch condition; and

a branch condition storage unit that includes a plurality of storage regions which stores therein branch conditions each set by the condition setting instruction;

when an instruction decoded by an instruction decoder is the condition setting instruction, the branch condition storage unit storing the branch condition specified by the condition setting instruction in one of the storage regions corresponding to the priority order.

The processor apparatus according to the present invention includes:

a branch destination address storage unit capable of storing therein a plurality of branch destination addresses each for branching when a branch condition holds;

a branch destination address at a time of establishment of the branch condition specified by the condition setting instruction being specified by the condition setting instruction;

when the instruction decoded by the instruction decoder is the condition setting instruction, the branch destination address specified by the condition setting instruction being stored in the branch destination address storage unit, being associated with the priority order specified by the condition setting instruction.

In one embodiment of the present invention, the instruction set includes a conditional branch instruction whereby a determination on the branch condition is made and branching to the branch destination address is performed when the branch condition holds. The processor apparatus includes:

a branch condition comparison unit including one or a plurality of condition comparison units which make one or a plurality of individual determinations on one or a plurality of branch conditions stored in the branch condition storage unit when the conditional branch instruction is executed, with the one or the plurality of branch conditions set in the branch condition storage unit and one or a plurality of branch destination addresses stored in the branch destination address storage unit after one or a plurality of the condition setting instructions have been executed; and

a conditional branch determination unit that selects from the branch destination address storage unit the branch destination address corresponding to the branch condition stored in a predetermined one of the storage regions of the branch condition storage unit according to a prioritization method set in advance, when there are a plurality of comparison operation results of the plurality of the condition comparison units indicating that a plurality of the branch conditions simultaneously hold; and

branching is performed to the branch destination address selected by the conditional branch determination unit.

In one embodiment of the present invention, the condition determination unit selects from the branch destination address storage unit the branch destination address corresponding to the branch condition stored in one of the storage regions of the branch condition storage unit with a highest priority order among the branch conditions that simultaneously hold, and the branching is performed to the branch address.

In one embodiment of the present invention, when one branch condition holds, the condition determination unit selects a branch destination address corresponding to the one branch condition, and branching is performed to the branch address.

In one embodiment of the present invention, when no branch condition holds, the condition determination unit outputs information indicating that no branch condition holds, the branching is not performed, and a program counter is incremented by one.

In one embodiment of the present invention, the branch condition stored in each of the storage regions of the branch condition storage unit includes:

first and second register addresses of two operation registers targeted for comparison;

immediate value data;

a flag that stores a type of a comparison operation between data in the operation registers or a comparison operation between data in one of the operation registers and the immediate value data; and

a type of a comparator operation.

In one embodiment of the present invention, the condition setting instruction includes in an operand thereof:

information that functions as priority order information and specifies one of the storage regions of the branch conditions in the branch condition storage unit;

the comparison operation type;

the first register address of the operation register and the second register address of the operation register targeted for the comparison operation or the immediate value data; and

the branch destination address.

In one embodiment of the present invention, the branch condition storage unit includes:

a plurality of condition storage units as the storage regions; and

a selector that selects one of the condition storage units that stores therein the branch condition specified by the condition setting instruction based on the priority order information on the branch condition specified by the condition setting instruction decoded by the instruction decoder.

In one embodiment of the present invention, there are provided a plurality of the branch condition storage units; and another selector that selects one of the branch condition storage units.

In one embodiment of the present invention, the condition setting instruction includes in the operand thereof:

information that specifies one of the branch condition storage units;

the information that functions as the priority order information and specifies the one of the storage regions of the branch conditions in the branch condition storage unit;

the comparison operation type;

the first register address of the operation register and the second register address of the operation register targeted for the comparison operation or the immediate value data; and

the branch destination address.

In one embodiment of the present invention, the branch condition storage unit includes:

a plurality of condition storage units each of which stores therein the condition composed of:

the first and second register addresses of the two operation registers targeted for comparison;

the immediate value data;

the flag that stores the type of the comparison operation between data in the operation registers or the comparison operation between data in the one of the operation registers and the immediate value data; and

the comparator operation type, as one set;

the condition storage units constitute the storage regions that store therein the branch conditions; and

the processor apparatus includes:

a selector that selects one of the condition storage units.

In one embodiment of the present invention, the branch condition comparison unit includes sets of the condition comparison units each including:

first and second decoders that respectively decode the first and second addresses stored in a corresponding one of the condition storage units, respectively output the first and second register addresses to the operation registers, and respectively hold data read from the operation registers;

a third selector that receives the immediate data stored in the corresponding one of the condition storage units and a value of the second decoder, and selects one of the immediate data and the value of the second decoder based on an output of the flag; and

a comparator that receives an output of the third selector and an output of the first decoder as inputs and performs an operation corresponding to the operation type stored in the complex condition storage unit;

the sets of the condition comparison units being provided corresponding to the condition storage units, respectively.

In the processor apparatus according to the present invention, the branch condition stored in the branch condition storage unit by execution of the condition setting instruction is held until another condition setting instruction is executed after execution of the condition setting instruction and then the branch condition is rewritten to another condition by the another condition setting instruction.

In the processor apparatus according to the present invention, the branch destination address stored in the branch condition storage unit by execution of the condition setting instruction is held until another condition setting instruction is executed after execution of the condition setting instruction and then the branch destination address is rewritten to another branch destination address by the another condition setting instruction.

In the processor apparatus according to the present invention,the conditional branch determination unit includes:

a second selector that stores the branch destination address specified by the condition setting instruction in a corresponding storage region of the branch destination address storage unit based on the priority order specified by the condition setting instruction decoded by the instruction decoder;

a priority encoder that receives the comparison operation results from the condition comparison units, outputs a signal that selects one branch destination address according to the prioritization method set in advance when the plurality of the comparison operation results indicate that the plurality of the branch conditions hold, and outputs a signal that selects the branch destination address corresponding to one branch condition when the one branch condition holds;

a third selector that selects the branch destination address selected by the priority encoder from among the plurality of branch destination addresses stored in the branch destination address storage unit;

a logic circuit that outputs a first value when all of the comparison operation results from the condition comparison units indicate that no branch condition holds, and outputs a second value for the other combinations of the comparison operation results from the condition comparison units; and

a fourth selector that receives an output of a program counter and an output of the third selector, and sets the output of the program counter or the output of the third selector in the program counter according to whether an output of the logic circuit assumes the first value or the second value.

In one embodiment of the present invention, the conditional branch determination unit includes:

a second selector that stores the branch destination address in a corresponding storage region of the branch destination address storage unit based on information specifying the storage region of the branch condition and the branch destination address specified by the condition setting instruction decoded by the instruction decoder;

a counter that selects one of the branch destination addresses in the branch address storage unit and one of the branch conditions in the branch condition storage unit, using a count value output from the counter;

a third selector that selects the branch destination address selected by the counter from among the branch destination addresses stored in the branch destination address storage unit; and

a fourth selector that receives an output of a program counter and an output of the third selector and sets the output of the program counter or the output of the third selector according to whether an output of the condition comparison units indicates branch condition establishment or not;

condition comparison of the branch condition selected according to the count output of the counter being executed.

In one embodiment of the present invention, the branch condition comparison unit includes:

one condition comparison unit which makes the one or the plurality of individual determinations on the one or the plurality of branch conditions stored in the branch condition storage unit when the conditional branch instruction is executed, with the one or the plurality of branch conditions set in the branch condition storage unit and the plurality of branch destination addresses stored in the branch destination address storage unit after the one or the plurality of the condition setting instructions have been executed;

when the conditional branch instruction has been analyzed by the instruction decoder, the counter receives a reset signal from the instruction decoder and is reset to a number indicating a highest priority order;

the branch condition with the priority order corresponding to a count value of the counter is read from the branch condition storage unit and is then stored in the condition comparison unit; and

conditional branch determinations on the branch conditions are sequentially made in descending order of priority orders, and branching to the branch destination address selected at a point of time when one of the branch conditions holds is performed.

In one embodiment of the present invention, there is provided a processor apparatus that comprises:

an instruction set which includes:

a condition setting instruction that sets a branch condition and a branch destination address when the branch condition holds, corresponding to a specified priority order; and

a conditional branch instruction that determines whether or not at least one branch condition set by the branch condition setting instruction holds, and causes branching to a corresponding one of branch destination addresses when the at least one branch condition holds;

a branch condition storage unit that stores therein one or a plurality of branch conditions specified by one or a plurality of the condition setting instructions corresponding to priority orders specified by the condition setting instructions, respectively;

a branch destination address storage unit that stores one or a plurality of branch destination addresses specified by the one or the plurality of the condition setting instructions corresponding to the priority orders specified by the condition setting instructions, respectively; and

means for selecting from the branch destination address storage unit the branch destination address corresponding to the branch condition stored in a predetermined storage region of the branch condition storage unit according to a prioritization method set in advance, when individual determinations on the one or the plurality of branch conditions already stored in the branch condition storage unit are made and a plurality of the branch conditions simultaneously hold at a time of execution of the conditional branch instruction, wherein in a state where the one or the plurality of branch conditions have been set in the branch condition storage unit and the one or the plurality of branch destination addresses have been stored in the branch destination address storage unit by execution of the one or the plurality of the condition setting instructions, at least one other instruction being allowed to be executed during execution of the conditional branch instruction after execution of the one or the plurality of the condition setting instructions.

According to the present invention, there is provided a method for processing a conditional branch in a processor, wherein when a decoded instruction is a conditional setting instruction, a branch condition specified by the condition setting instruction is stored in a storage region of a branch condition storage unit corresponding to a priority order specified by the condition setting instruction, the branch condition storage unit storing therein a plurality of branch conditions.

In the method according to the present invention, in the condition setting instruction, a branch destination address when the branch condition specified by the condition setting instruction holds is specified; and

when the decoded instruction is the condition setting instruction, the branch destination address specified by the condition setting instruction is stored corresponding to the priority order of the branch condition.

In the method according to the present invention, after one or a plurality of the condition setting instructions have been executed and then branch conditions and branch destination addresses have been stored,

individual determinations on the stored branch conditions are made at a time of execution of a conditional branch instruction; and

when a plurality of the branch conditions holds, branching to the branch destination address corresponding to the branch condition selected according to a prioritization method set in advance is performed.

According to the present invention, a plurality of branch conditions can be stored by execution of the condition setting instructions a plurality of times. Accordingly, when the present invention is applied to loop processing or the like where a branch condition is repeatedly executed, conditional branching can be processed by execution of only one conditional branch instruction in the loop processing. Higher-speed processing is thereby achieved.

Still other features and advantages of the present invention will become readily apparent to those skilled in this art from the following detailed description in conjunction with the accompanying drawings wherein only exemplary embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram showing a configuration of an exemplary embodiment of the present invention;

FIG. 2 is a diagram showing a configuration example of a branch condition storage unit in the exemplary embodiment of the present invention;

FIG. 3 is a diagram showing an example of a branch condition comparison unit and its pertinent portion in the exemplary embodiment of the present invention;

FIGS. 4A and 4B are diagrams showing an example of a conditional branch determination unit and its pertinent portion in the exemplary embodiment of the present invention;

FIG. 5 is a diagram showing a variation example of the exemplary embodiment of the present invention;

FIG. 6 is a diagram showing an example of a program that uses condition setting instructions and a conditional branch instruction in the exemplary embodiment of the present invention;

FIG. 7 is a diagram showing a configuration of a conditional branch determination unit in another exemplary embodiment of the present invention;

FIG. 8 is a diagram showing an example of a branch condition storage unit in the another exemplary embodiment of the present invention;

FIGS. 9A and 9B are diagrams one of which shows an example of a condition setting instruction in still another exemplary embodiment of the present invention;

FIG. 10 is a diagram showing an example of a common program that uses a conditional branch instruction;

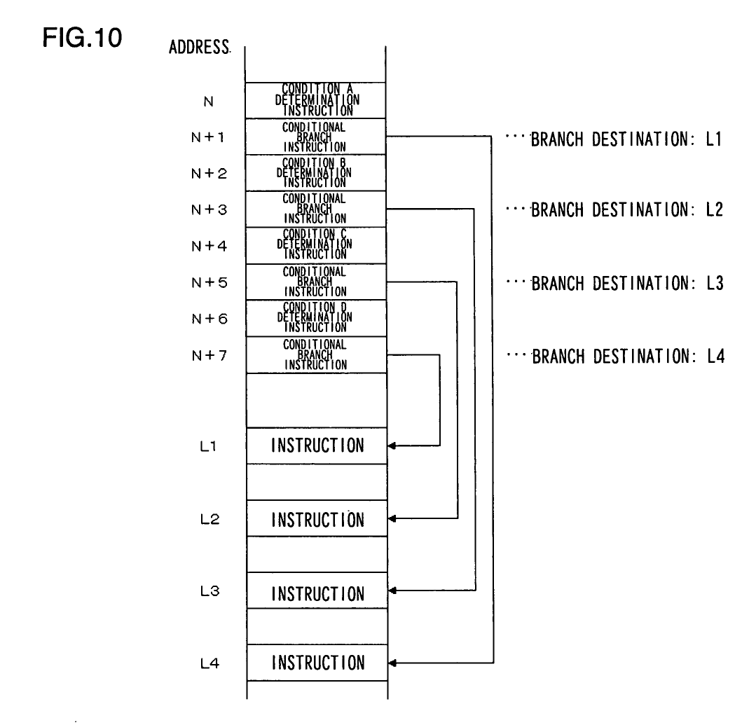

FIG. 11 is a diagram showing a configuration of Patent Document 1;

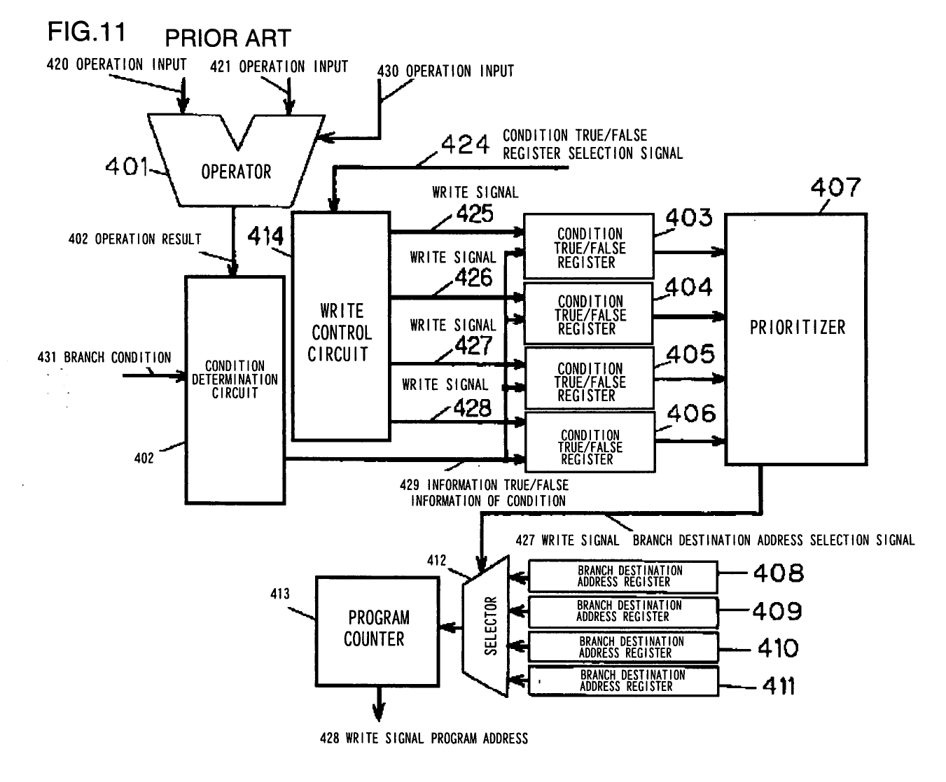

FIG. 12 is a diagram showing an example of a program that uses a conditional branch instruction in Patent Document 1; and

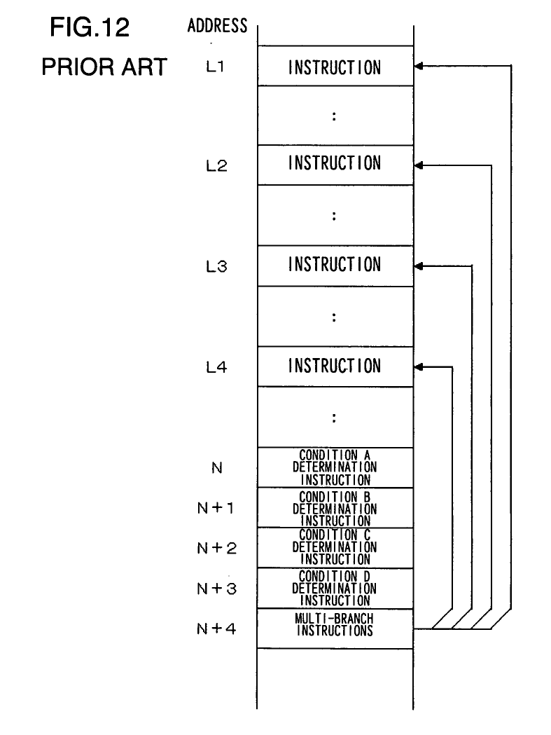

FIG. 13 is a diagram showing an example of a conditional branch processing program in Patent Document 3.

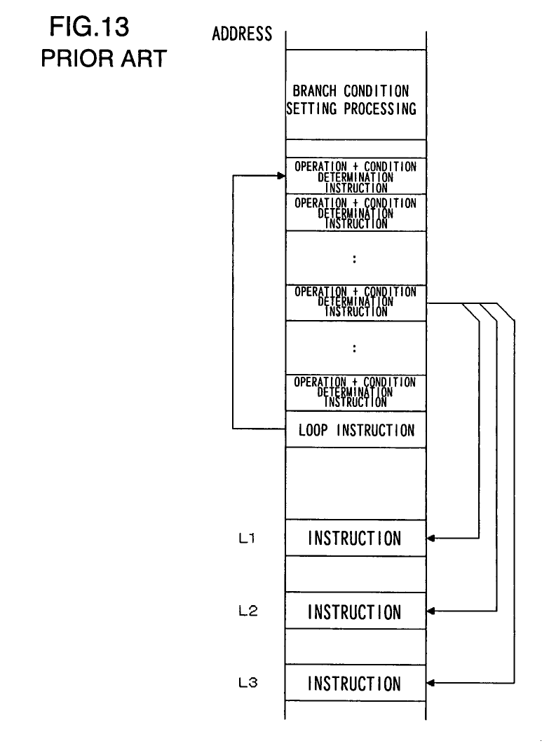

### PREFERRED MODES OF THE INVENTION

In a processor according to the present invention, there are provided a branch condition storage unit (1), an instruction decoder (2), a branch condition comparison unit (5), a conditional branch determination unit (6), a selector (7), and a program counter (8). The branch condition storage unit (1) includes a plurality of storage regions (condition storage units) for storing a plurality of branch conditions, respectively. The instruction decoder decodes an instruction code. The branch condition comparison unit (5) performs a comparison operation for each branch condition. The conditional branch determination unit (6) determines whether or not to perform program branching in a conditional branch instruction. The selector (7) makes selection between a branch destination address and a next instruction address based on an output value of the conditional branch determination unit (6). The program counter (8) indicates the address of a next instruction to be executed. The branch condition specified by a condition setting instruction (SETCMP) is stored in one of the storage regions in the branch condition storage unit (1) specified by the condition setting instruction (SETCMP). When a conditional branch instruction (XBRA) is executed, the branch condition comparison unit (5) makes individual determinations on a plurality of the branch conditions stored in the branch condition storage unit (1). Upon receipt of comparison results from the branch condition comparison unit (5), the conditional branch determination unit (6) selects from a branch destination address storage unit (6c) the branch address corresponding to the branch condition stored in a predetermined one of the storage regions among the branch conditions that simultaneously hold, and branching to the branch address is performed.

An instruction set of the processor includes:

a condition setting instruction (branch condition setting instruction) capable of specifying information (such as first and second register addresses targeted for comparison or an immediate value) necessary for making a determination on each branch condition; and

a conditional branch instruction whereby determinations on the plurality of branch conditions are made using information in the conditional setting instruction executed a plurality of times in advance and branching to the branch address corresponding to one branch condition that has a highest priority among branch conditions that simultaneously hold can be performed. A plurality of branch conditions are executed just with an execution time and an instruction storage region corresponding one step.

The condition setting instruction can prioritize branch conditions and branch destination addresses.

The conditional branch instruction determines whether or not a plurality of branch conditions set in advance by the condition setting instruction are true, using one instruction. When there are the branch conditions that simultaneously hold, the branch destination address corresponding to the one of the branch conditions having the highest priority is selected, as an address of a next instruction to be executed.

The branch conditions can be stored by execution of the condition setting instruction the plurality of times in advance. Thus, when the present invention is applied to loop processing, where the same branch condition is repeatedly executed, conditional branching can be processed just by execution of only one conditional branch instruction in the loop processing. High-speed processing can be thereby performed.

Even when the instruction length of the condition setting instruction extends 2 words or more due to an increase in an information amount of branch conditions and branch destination addresses, the instruction length and the number of steps of execution of the condition setting instruction are just increased. The instruction length and the number of steps of execution of the conditional branch instruction are not increased.

### First Exemplary Embodiment

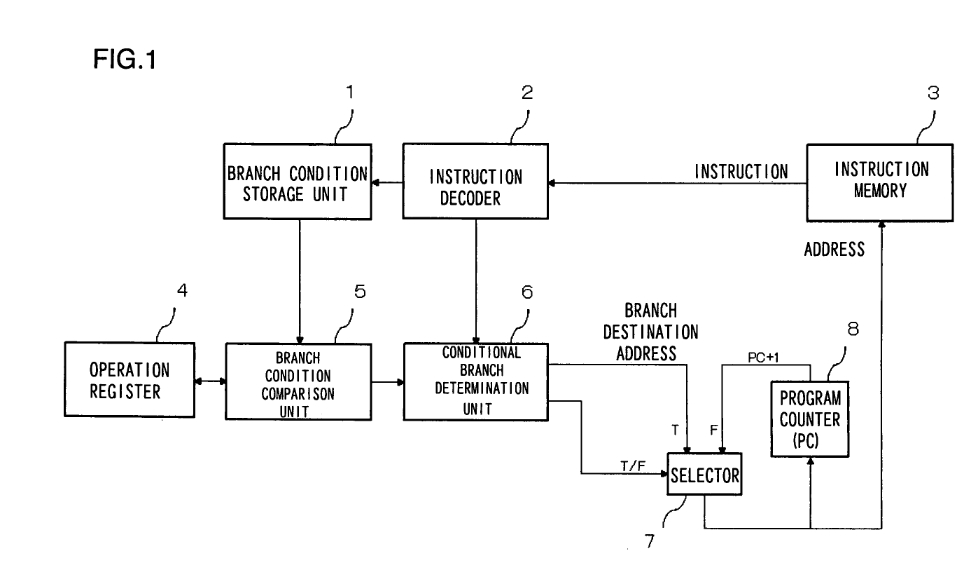

FIG. 1 is a diagram showing a configuration of an exemplary embodiment of the present invention. Referring to FIG. 1, a processor apparatus in this exemplary embodiment includes a branch condition storage unit 1 capable of storing a plurality of branch conditions, an instruction decoder 2 that holds and analyzes a code for an instruction and controls a block related to the instruction, an instruction memory 3 that stores therein instruction codes, an operation register (register file) 4 to be used for an operation by a processor, a branch condition comparison unit 5 that performs a comparison operation for each of branch conditions, a conditional branch determination unit 6 that determines whether or not to perform branching of a program in a conditional branch instruction, a selector 7 that makes selection between a branch destination address and a next instruction address based on an output value of the conditional branch determination unit 6, and a program counter (PC) 8 that indicates an instruction executing position of the processor.

In this exemplary embodiment, a condition setting instruction (of which the mnemonic is SETCMP, and the syntax will be described later) is the instruction that sets information (including a branch destination address to be jumped when a branch condition holds) necessary for the comparison operation for the branch condition in the branch condition storage unit 1. The condition setting instruction specifies a priority order and stores the information necessary for the comparison operation in a specified storage region in the branch condition storage unit 1 (storage region corresponding to the priority order).

The conditional branch instruction (of which the mnemonic is XBRA) determines whether a plurality of branch conditions hold or not. The plurality of branch conditions are set by execution of a plurality of the condition setting instructions, each specifying a branch condition, a branch destination address, and a priority order, in advance. When a plurality of the branch conditions that simultaneously hold are present, the conditional branch instruction selects the branch destination address corresponding to the branch condition having the highest priority among the branch conditions that have simultaneously held, as an address of a next instruction to be executed. The execution of the condition setting instruction before a loop and execution of loop completion determination by one conditional branch instruction contributes to processing time reduction of loop operations that are repeatedly executed.

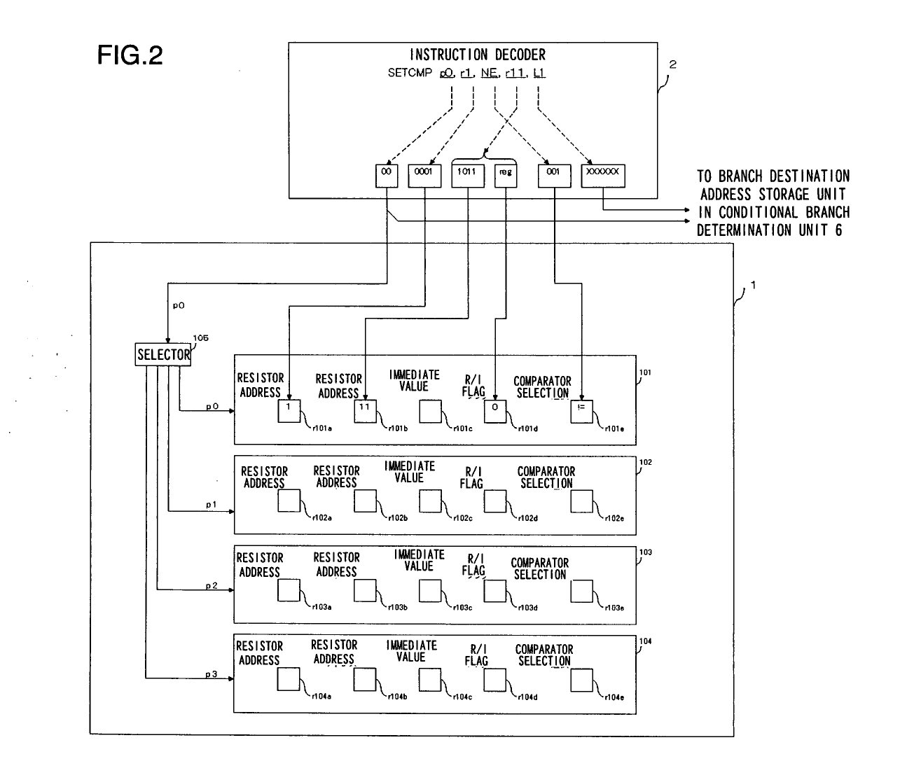

FIG. 2 is a diagram for explaining an example of a configuration of the branch condition storage unit 1 in FIG. 1. In the branch condition storage unit 1,a branch condition specified by the condition setting instruction decoded by the instruction decoder 2 is stored. That is, by executing one condition setting instruction, one branch condition specified by the condition setting instruction is stored in the specified storage region in the branch condition storage unit 1. By executing a plurality of the condition setting instructions, a plurality of branch conditions each specified by each condition setting instruction are stored in a plurality of storage regions in the branch condition storage unit 1. In this exemplary embodiment, by execution of one conditional branch instruction, the plurality of branch conditions stored in the plurality of storage regions in the branch condition storage unit 1 are evaluated, and branching is performed when one of the branch conditions holds.

In this exemplary embodiment, in order to give the priority order specified by the condition setting instruction (SETCMP) to the branch condition specified by the condition setting instruction (SETCMP) and to store the branch condition having the priority order in the branch condition storage unit 1,the priority order of each branch condition storage location in the branch condition storage unit 1 is determined in advance.

Referring to FIG. 2, the branch condition storage unit 1 includes condition storage units 101 to 104, each of which stores therein one branch condition, as the plurality of storage regions. The branch condition storage unit 1 further includes a selector 105 that selects one of the condition storage units 101 to 104.

The condition storage unit 101 includes:

a register r101a that stores therein a first register address of two registers that perform a conditional operation (binary operation) for branch determination of a branch setting instruction;

a register r101b that stores therein a second register address;

a register r101c that stores therein an immediate value;

a register r101d that stores therein an R/I (R=Register: which denotes a register address, I=Immediate: which denotes an immediate value) flag indicating whether to use the two resistors or the immediate value in a binary comparison operation; and

a register r101e that stores therein the type of a comparison operation element that performs the operation. Each of the condition storage units 102 to 104 has the same structure.

The instruction syntax of an assembler for the condition setting instruction will be described.

The condition setting instruction is the instruction that sets information necessary for a comparison operation for a branch condition in the branch condition storage unit. The mnemonic of the op code is “SETCMP” and has the following operand format (syntax).

SETCMP p0, r1, NE, r11, L1 (1)

The first operand “p0” denotes a branch condition having a first priority order, and indicates the condition storage unit 101. Likewise, “p1”, “p2”, “p3” correspond to the condition storage units 102, 103, and 104, respectively. Though no particular limitation is not imposed, in this exemplary embodiment, the four condition storage units are provided at the branch condition storage unit 1,and the maximum of four branch conditions are simultaneously stored. The priority order p0 and priority orders p1, p2, p3 correspond to 00b (b indicating binary representation), 01b, 10b, and 11b, respectively.

The second and fourth operands “r1” and “r11” respectively indicate registers in the operation register 4 at register addresses I and 11.

The third operand “NE” indicates a type “!=” of the comparison operation element used, in case values of r1 and r11 are compared.

The fifth operand “L1” indicates a branch destination address to which a jump is made when this branch condition holds.

The following table 1 indicates examples of types of comparison operation elements specified by the condition setting instruction (SETCMP), of which mnemonics, meanings, C language notation, and selected values (corresponding binary codes of the types of comparison operation elements) are shown.

TABLE 1
Types of Comparison Operation Elements

| Type (Mnemonic | | C language | |
|---|---|---|---|
| Notation) | Meaning | Notation | Selected Value |
| EQ | Equal | ‘==’ | 0(000b) |
| NE | Not Equal | ‘!=’ | 0(001b) |
| L | Less | ‘<’ | 2(010b) |
| LE | Less or Equal | ‘<=’ | 3(011b) |
| G | Greater | ‘>’ | 4(100b) |
| GE | Greater or Equal | ‘>=’ | 5(101b) |

Referring to FIG. 2, a state where the instruction decoder 2 has decoded the instruction code of the condition setting instruction (SETCMP) and then the instruction code has been broken down into bit strings is shown. The branch condition “p0” (00b) is supplied to the selector 105, so that the condition storage unit 101 is selected. The address “r1” (0001b) is supplied to the register r101a and is then stored. The address “r11” (1011b) is supplied to the register r101b and is then stored. The R/I flag (0b) is supplied to the register r101d, and is then stored. The comparison operation element type “NE” (001b) is supplied to the register r101e and is then stored.

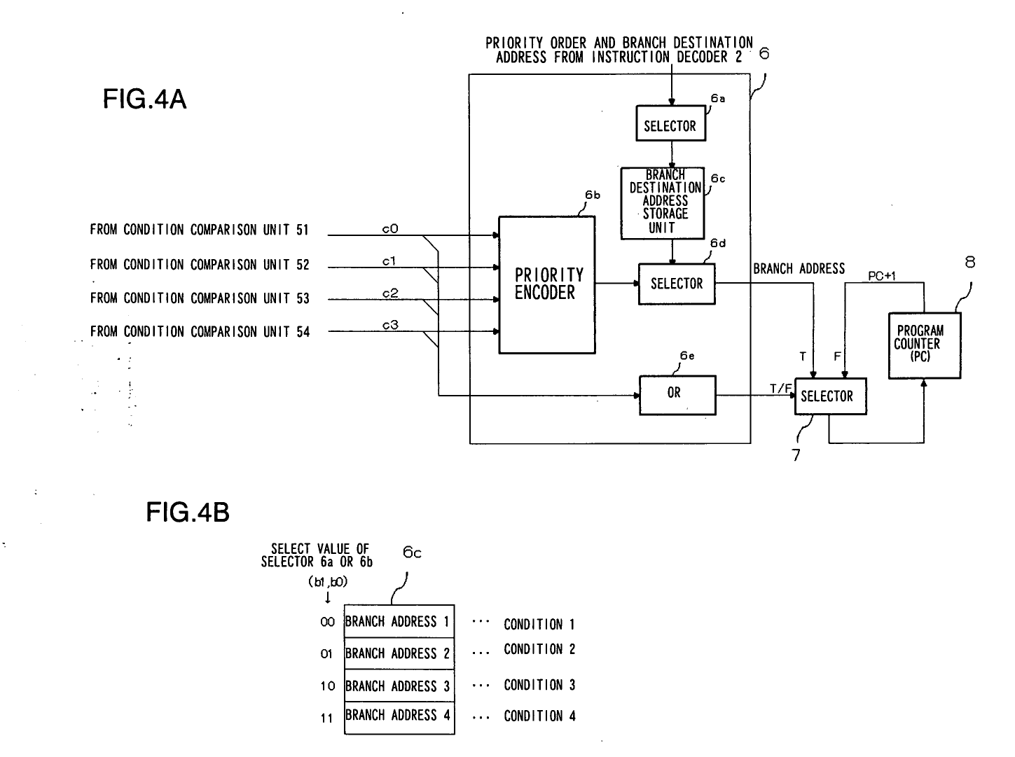

Values of the branch condition “p0” and the branch destination address “L1” analyzed by the instruction decoder 2 are supplied to the conditional branch determination unit 6. The value of the branch destination address “L1” is supplied to a branch destination address storage unit (indicated by reference numeral 6c in FIG. 4) corresponding to the branch condition “p0” (00b) in the conditional branch determination unit 6 and is then stored.

The values stored in the branch condition storage unit 1 and the branch destination address storage unit, respectively, are held as long as the condition setting instruction for the same location of the branch condition storage unit and the branch destination address storage unit are not executed.

The conditional branch instruction is the instruction by which a comparison operation for each branch condition set by the condition setting instruction (SETCMP) is performed and a determination on the branch condition is made based on the result of the comparison operation. The conditional branch instruction is indicated by the mnemonic of the assembler as follows.

XBRA (2)

“XBRA” indicates a name of the conditional branch instruction. No other information is needed. That is, no operand is needed. In this exemplary embodiment, the conditional branch instruction is composed of only an op code.

When the conditional branch instruction is decoded by the instruction decoder 2, the branch condition comparison unit 5 executes comparison operations for a plurality of branch conditions set in the branch condition storage unit 1 by execution of the condition setting instruction (SETCMP) in advance.

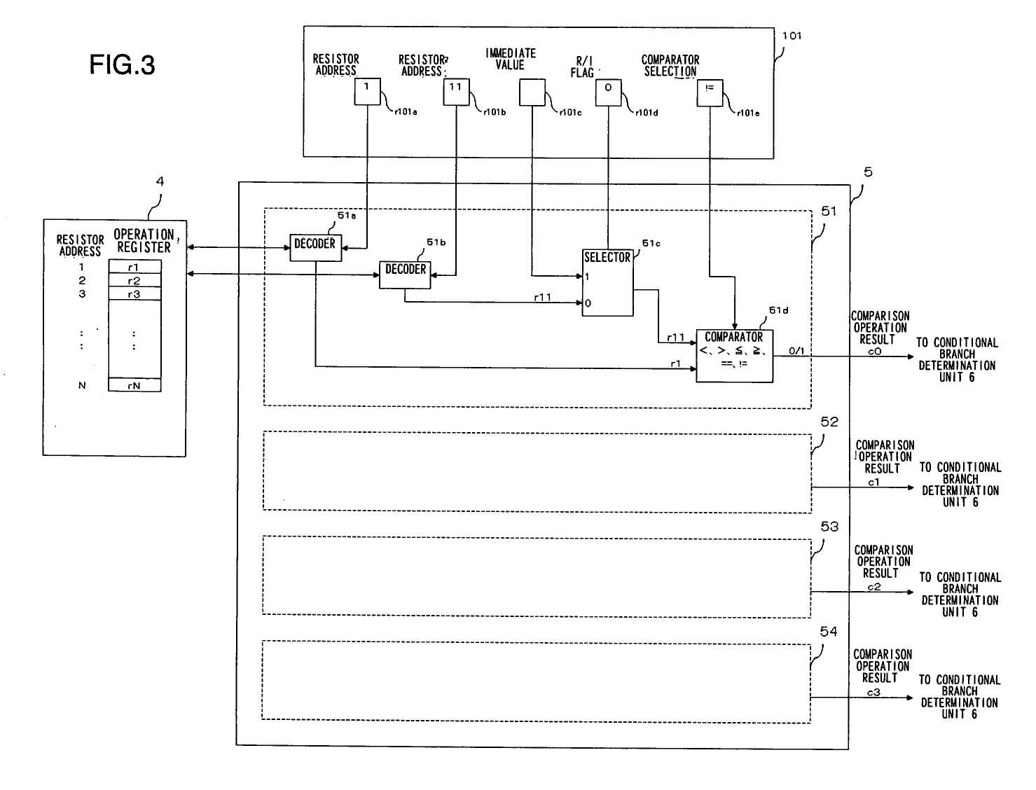

FIG. 3 is a diagram showing an example of a configuration of the branch condition comparison unit 5 in FIG. 1. Referring to FIG. 3, the branch condition comparison unit 5 includes a plurality of condition comparison units 51, 52, 53, and 54, corresponding to the condition storage units 101, 102, 103 and 104, respectively. Each of the condition comparison units 51, 52, 53, and 54 performs a comparison operation for a branch condition

The condition comparison unit 51 includes a decoder 51a, a decoder 51b, a selector 51c, and a comparator 51d. The decoder 51a obtains the value of a corresponding register from the operation register 4 using the first register address of the register r101a of the condition storage unit 101 in the branch condition storage unit 1. The decoder 51b obtains the value of a corresponding register from the operation register 4 using the second register address of the register r101b. The selector 51c selects one of the immediate value of the register r101d of the condition storage unit 101 and the value of the register in the operation register 4 selected by the decoder 51b, based on the value of the R/I flag in the register r101d of the condition storage unit 101. The comparator 51d performs the comparison operation between the value of the register in the operation register 4 selected by the decoder 51a and the value output from the selector 51a, and outputs a comparison operation result c0 to the conditional branch determination unit 6.

The condition comparison unit 51 performs the comparison operation based on set values of the registers (r101a, r101b, r101c, r101d, and r101e) of the condition storage unit 101, and outputs the comparison operation result c0 to the conditional branch determination unit 6.

Each configuration of the condition comparison units 52, 53, and 54 is also set to be the same as that of the condition comparison unit 51.

The condition comparison units 52, 53, and 54 respectively receive outputs of respective registers (r102a, r102b, r102c, r102d, and r102e) of the condition storage unit 102, outputs of respective registers (r103a, r103b, r103c, r103d, and r103e) of the condition storage unit 103, and outputs of respective registers (r104a, r104b, r104c, r104d, and r104e) of the condition storage unit 104 in the branch condition storage unit 1, and respectively output comparison operation results c1, c2, and c3 to the conditional branch determination unit 6.

This exemplary embodiment shows a case where the maximum of four branch conditions can be processed. In the branch condition comparison unit 5, the condition comparison unit 51 is configured to form a pair with the condition storage unit 101, the condition comparison unit 52 is configured to form a pair with the condition storage unit 102, the branch condition comparison unit 53 is configured to form a pair with the condition storage unit 53, and the branch condition comparison unit 54 is configured to form a pair with the condition storage unit 104.

When the conditional branch instruction (XBRA) is decoded by the instruction decoder 2, two processing is executed.

In first processing, using information on the branch conditions stored in the branch condition storage unit 1,the comparison operations for the respective branch conditions are simultaneously performed at the branch condition comparison unit 5, and the comparison operation results c0 to c3 are output to the conditional branch determination unit 6, as described with reference to FIG. 3.

In second processing, the comparison operation results c0 to c3 are supplied to a priority encoder 6b, as shown in FIG. 4A. Then, it is arranged so that even if the conditions for which the comparison operation results c0 to c3 are obtained simultaneously hold, one of the conditions having the highest priority (such as the comparison operation result c0) is selected.

FIG. 4A is a diagram showing an example of a configuration of the conditional branch determination unit 6 in FIG. 1. Referring to FIG. 4A, the conditional branch determination unit 6 includes a selector (decoder) 6a, the branch destination address storage unit 6c, a priority encoder 6b, a selector 6d, and an OR circuit 6e. The selector 6a receives a priority order and a branch destination address which are a result of decoding of the SETCMP instruction by the instruction decoder 2. The branch destination address storage unit 6c stores the branch destination address at a select address selected by the selector 6a. The priority encoder 6b receives the comparison results c0, c1, c2, and c3 from the branch condition comparison unit 5, and selects the condition comparison unit that has performed comparison about the branch condition having the highest priority when a plurality of the comparison operation results C0 to C3 hold. The selector 6d selects one of branch destination addresses stored in the branch destination address storage unit 6c corresponding to the branch condition selected by the priority encoder 6b. The OR circuit 6e receives the comparison results c0, c1, c2, and c3 from the branch condition comparison unit 5.

The OR circuit 6e outputs a value F as a selection control signal 7 for the selector 7 when the comparison operation results c0, c1, c2, and c3 from the branch condition comparison unit 5 are all 0. The selector 7 sets a value PC+1 in the program counter 8 (with no branching performed).

When at least one of the comparison operation results c0, c1, c2, and c3 from the branch condition comparison unit 5 is 1, the OR circuit 6e outputs a value T as the selection control signal for the selector 7. The selector 7 sets the branch destination address from the selector 6d in the program counter 8.

As shown in FIG. 4B, as a select value of the selector 6a, the value of “p0” (00b) extracted from the condition setting instruction is given, and the value of the branch destination address is stored in the corresponding storage region (location of a condition A). That is, the branch destination addresses stored in the branch destination address storage unit 6d are arranged in the order of priorities.

Which one of the values of 00b and 11b has a higher priority order differs according to a prioritization method in the priority encoder 6b in FIG. 4A.

The branch destination address storage unit 6c outputs the stored branch addresses to the selector 6d. Based on the result of selection by the priority encoder 6b, the selector 6d selects a corresponding one of the branch addresses in the branch destination address storage unit 6c and outputs the selected branch address to the selector 7.

Though no particular limitation is imposed, in the priority encoder 6b in this exemplary embodiment, the priority order is increased in the order of the comparison operation results c3, c2, c1, and c0. That is, when the comparison operation result c0 is 1 and when at least one of the comparison operation results c1 to c3 is 1 at the same time, the priority encoder 6b selects the comparison operation result c0 and outputs an output 00b. When the comparison operation result c0 is 0 and the comparison operation result c1 is 1, and when at least one of the comparison operation results c2 and c3 is 1 at the same time, the priority encoder 6b selects the comparison operation result c1, and outputs an output 01b. When the comparison operation results c0 and c1 are 0 and the comparison operation result c2 is 1, and when the comparison operation result c3 is 1 at the same time, the priority encoder 6b selects the comparison operation result c2, and outputs an output 10b. When the comparison operation results c0, c1, and c2 are 0 and the comparison operation result c3 is 1, the priority encoder 6b selects the comparison operation result c3 and outputs an output 11b. When one ci (in which i is one of 0 to 3) of the comparison operation results c0, c1, c2, and c3 is 1, and the other comparison operation results are 0, the priority encoder 6 outputs a two-bit code corresponding to i of the comparison operation result ci. The priority encoder 6b controls selection of the selector 7d so that the branch destination address for which the comparison operation result is 1 is selected.

A truth-value table indicating an operation of the priority encoder 6b is as shown in the following Table 2, in which b0 and b1 indicate output values of a selection control signal of the selector 6d.

When (b0, b1) are (0, 0), (0, 1), (1, 0) and (1, 1), branch destination addresses 1, 2, 3, and 4 stored in the branch destination address storage unit 6c in FIG. 4B are respectively selected.

TABLE 2
Example of Truth-value Table of Priority Encoder

| c3 | c2 | c1 | c0 | b1 | b0 |
|---|---|---|---|---|---|
| 0 | 0 | 0 | 0 | 0 | 0 |
| 0 | 0 | 0 | 1 | 0 | 0 |
| 0 | 0 | 1 | 0 | 0 | 1 |
| 0 | 0 | 1 | 1 | 0 | 0 |
| 0 | 1 | 0 | 0 | 1 | 0 |
| 0 | 1 | 0 | 1 | 0 | 0 |
| 0 | 1 | 1 | 0 | 0 | 1 |
| 0 | 1 | 1 | 1 | 0 | 0 |
| 1 | 0 | 0 | 0 | 1 | 1 |
| 1 | 0 | 0 | 1 | 0 | 0 |
| 1 | 0 | 1 | 0 | 0 | 1 |
| 1 | 0 | 1 | 1 | 0 | 0 |
| 1 | 1 | 0 | 0 | 1 | 0 |
| 1 | 1 | 0 | 1 | 0 | 0 |
| 1 | 1 | 1 | 0 | 0 | 1 |
| 1 | 1 | 1 | 1 | 0 | 0 |

In this exemplary embodiment, condition setting is performed by the condition setting instruction (SETCMP) in advance. In a stage where conditional branching is performed, only the number of steps necessary for execution of one conditional branch instruction is thereby needed. Thus, higher-speed branch processing can be performed. By applying this exemplary embodiment to loop processing where the same condition is repeatedly executed, a loop operation time is reduced. Thus, this exemplary embodiment provides an operation and effect that further higher-speed loop processing is achieved.

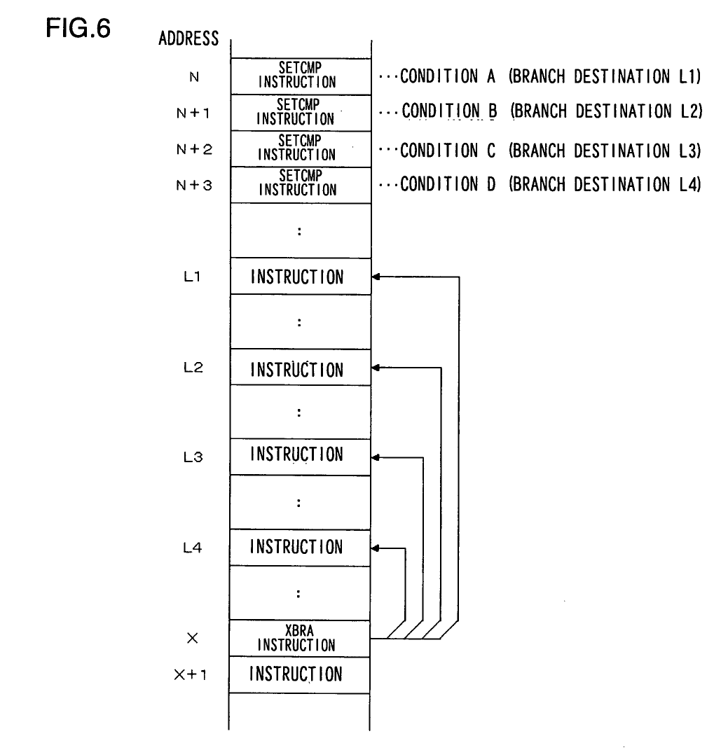

FIG. 6 is an explanatory diagram for explaining an example of the loop processing including a plurality of conditional branching in this exemplary embodiment. Using four instructions at addresses N to N+3 of the instruction memory as condition setting instructions (SETCMP), four branch conditions A to D (of which branch destination addresses are indicated by L1 to L4, respectively) are set. This setting processing should be performed just once, outside the loop processing.

Then, after processing that gives some influence on the branch conditions A to D has been executed, a conditional branch instruction at an address X is executed. In this case, when one of the branch conditions A to D is met, the operation is returned to the corresponding branch destination address, and a series of the processing is repeated.

When two or more of the branch conditions A to D hold, the branch condition with the highest priority order is selected, and the procedure is returned to the branch address corresponding to the branch condition. When the branch conditions A to D hold at the same time, the branch condition D corresponding to branching to the branch destination address L4 with the deepest nest level is selected, and branching to the branch destination address L4 is performed.

Further, when none of the conditions hold, branching is not performed. Thus, the operation exits the loop processing, so that a next instruction (at an address X+1) is executed.

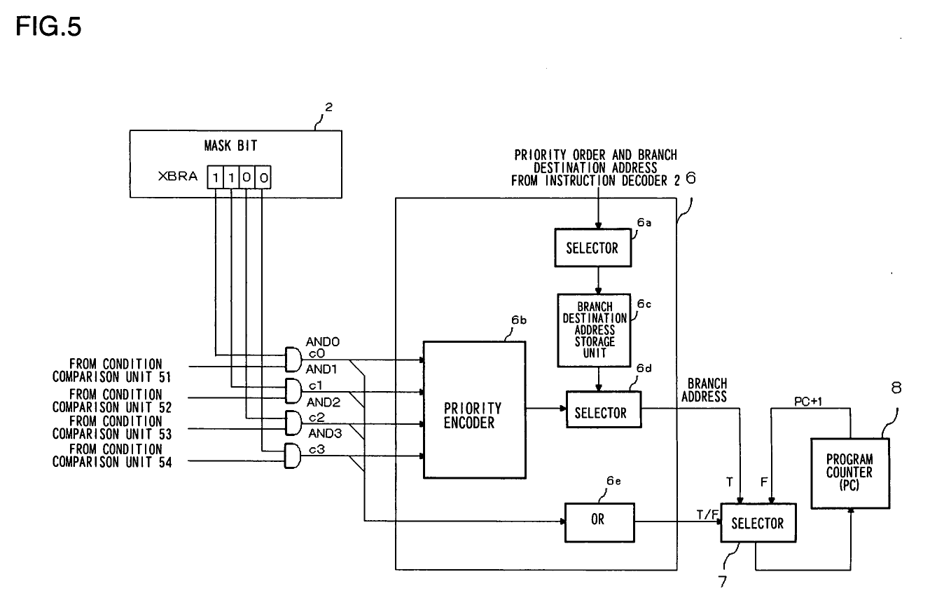

In this exemplary embodiment, the condition setting instruction (SETCMP) may be executed once and a branch condition may be set in one condition storage unit 101 among the condition storage units 101, 102, 103, and 104 of the branch condition storage unit 1. Then, when the conditional branch instruction (XBRA) is executed, comparison for the branch condition may be performed only by the branch condition comparison unit 51, thereby making branch determination. That is, this exemplary embodiment is not limited to a configuration in which the condition setting instructions (SETCMP) as a complex branch condition are executed four times and then branch conditions are set in the condition storage units 101 to 104, respectively, and the conditional branch instruction (XBRA) is executed to make determinations on the four branch conditions. One branch condition, or a complex branch condition such as two branch conditions, three branch conditions, or four branch conditions may be of course employed. When the condition setting instruction (SETCMP) is executed just once and branch determination is performed, the condition setting instruction (SETCMP) may specify the condition storage unit 101 with the highest priority order to set a branch condition, and the corresponding branch destination address may be stored in the branch destination address storage unit 6c. Then, when the branch condition comparison unit 5 uses only the condition comparison units 51 and 52 corresponding to the condition storage units 101 and 102, values of the unused comparison operation result c2 of the condition comparison unit 53 and the comparison operation result c3 of the unused comparison operation result c3 may be masked to 0. FIG. 5 is a diagram showing a configuration that implements such a function.

A mask bit is provided at the operand of the conditional branch instruction (XBRA).

XBRA mask bit (3)

The conditional branch instruction (XBRA) is decoded by the instruction decoder 2, and results obtained by taking AND operations between respective bits of the mask bit (composed of four bits in this exemplary embodiment) and respective comparison results of the condition comparison units 51, 52, 53, and 54 are supplied to the priority encoder 6b as comparison results c0, c1, c2, and c3. In an example shown in FIG. 5, the conditional branch instruction (XBRA) transmits the comparison operation results of the condition comparison units 51 and 52 to the priority encoder 6b as the comparison operation results c0 and c1. Then, the comparison operation results of the condition comparison units 53 and 54 are set to 0 and are given to the priority encoder 6b.

In the first exemplary embodiment, the number of branch conditions capable of being stored in the branch condition storage unit 1 is in a one-to-one correspondence relationship with the number of condition comparison units. The present invention is not of course limited to such a configuration. Only one condition comparison unit 51 may be employed.

### Second Exemplary Embodiment

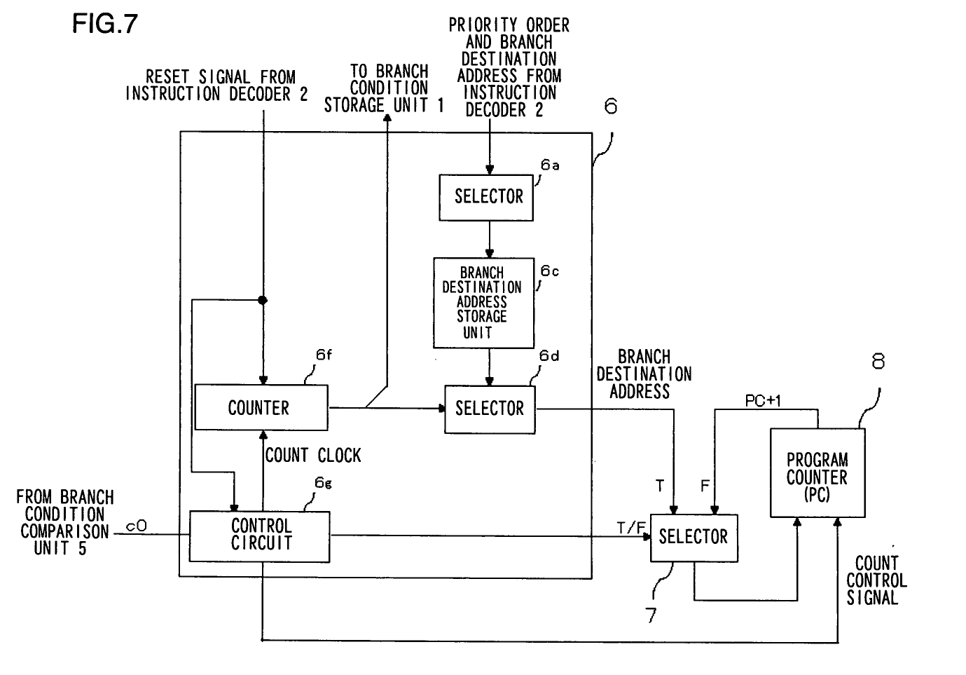

A second exemplary embodiment of the present invention is a configuration in which the branch condition comparison unit 5 includes one condition comparison unit 51. FIG. 7 is a diagram showing a configuration of a conditional branch determination unit 6 in a second exemplary embodiment of the present invention.

This exemplary embodiment includes a counter 6f (of which a count value is composed of two bits) in place of the priority encoder 6b in FIGS. 4 and 5.

The counter 6f selects a branch destination address in a branch address storage portion 6c and a branch condition in a branch condition storage unit 1.That is, the counter value of the counter 6f corresponds to a priority order, and the counter 6f functions as an address counter that selects the storage region (condition storage unit) of the branch condition storage unit 1 and the storage region of the branch destination address storage unit 6c according to the priority order.

An operation of the counter 6f will be described. First, the counter 6f receives a reset signal from an instruction decoder 2 when a conditional branch instruction (XBRA) has been decoded by the instruction decoder 2, and is reset to the number of the highest priority order (such as zero). As the reset signal, an arbitrary signal that is activated when the instruction decoder 2 has decoded the conditional branch instruction (XBRA) may be employed.

The count value of the counter 6f is supplied to a selector 105 of the branch condition storage unit 1 as a selection control signal. In this exemplary embodiment, the selector 105 of the branch condition storage unit 1 in FIG. 2 includes a selector (not shown) that makes selection between priority order information (composed of two bits) in a condition setting instruction from the instruction decoder 2 and an output (of two bits) of the counter 6f. When the condition setting instruction (SETCMP) is executed, the priority order information (composed of two bits) in the condition setting instruction from the instruction decoder 2 is supplied to the selector 105. When the conditional branch instruction (XBRA) is executed, the output of the counter 6f is selected, and is then supplied to the selector 105.

The branch condition having the priority order corresponding to the count value of the counter 6f is read from the selected condition storage unit of the branch condition storage unit 1,and is set in decoders 51a and 51b, a selector 51c, and a comparator 51d of a condition comparison unit 51. Further, the output (of two bits) of the counter 6f is supplied to a selector 6d as a selection control signal.

A comparison operation about the set branch condition is performed by the condition comparison unit 51. Then, a comparison operation result c0 is supplied to a control circuit 6g of a conditional branch determination unit 6. When the comparison operation result c0 has a value indicating that the branch condition holds (c0=1), the control circuit 6g outputs a value T (logical 1) as a selection control signal for a selector 7. The branch destination address in the storage region corresponding to the count value of the counter 6f is selected from among branch destination addresses stored in the branch destination address storage unit 6c, by the selector 6d, and is then output to a selector 7. Then, the branch destination address is set in a program counter 8.

When the branch condition does not hold (c0=0), the control circuit 6g outputs a count clock to the counter 6f so that the count value of the counter 6f is incremented by one (such as 1 increment). The counter 6f increases the count value by one, and sets the branch condition set in the condition storage unit of the branch condition storage unit 1 with the second priority order in the condition comparison unit 51. The output (of two bits) of the counter 6f is supplied to the selector 6d as the selection control signal. When a comparison operation result c0 from the condition comparison unit 51 about the branch condition with the second priority order has a value indicating that the branch holds (c0=1), the control circuit 6g outputs the value T (logical 1) as the selection control signal for the selector 7. On the other hand, when the comparison operation result c0 is 0, the control circuit 6g outputs the count clock so that the count value of the counter 6f is incremented by one (such as 1 increment). As described above, the control circuit 6g controls the counter 6f and performs control so that conditional branch determinations on branch conditions are sequentially made, starting from the branch condition with the highest priority order. When one of the branch conditions holds, the control circuit 6g performs control so that branching to the branch destination addresses selected at that point is performed. When none of the four branch conditions stored in condition storage units 101 to 104 in the branch condition storage unit 1 hold, the control circuit 6g outputs a value (F) indicating that no branch conditions hold, as the selection control signal for the selector 7. The selector 7 outputs a value PC+1 obtained by incrementing the current value of the program counter by 1 to the program counter 8.

In this exemplary embodiment, an execution cycle of the conditional branch instruction (XBRA) extends over a plurality of cycles except when the branch condition with the highest priority order holds. Then, the control circuit 6g supplies a count control signal to the program counter 8, and disenables an increment operation of the program counter 8 while the condition comparison unit 51 performs comparisons and the determinations as to whether the branch conditions hold, starting from the branch condition with the highest priority order. The control circuit 6g disenables the count control signal for the program counter 8, based on the reset signal output when the conditional branch instruction (XBRA) has been decoded by the instruction decoder 2. When presence or absence of branching is determined, the control circuit 6g causes the count control signal to be enabled. Only when the count control signal is enabled, the program counter 8 performs the operation of incrementing (to the value PC+1) or a branch destination address latching operation. The control circuit 6g may include four latch circuits that temporarily hold comparison operation results obtained by sequential execution of branch conditions stored in the four condition storage units 101 to 104 in the branch condition storage unit 1 by one condition comparison unit 51, respectively, an OR circuit that forms a logical sum of outputs of the four latch circuits, and a circuit that outputs a count clock for incrementing (or decrementing) the counter 6f by 1 when an output of the logical OR (OR) circuit indicates 0 and an overflow of the counter 6f does not occur. In a stage where the output of the logical OR circuit has indicated 1, the control circuit 6g may determine branch condition establishment and may output the value T(1) as the selection control signal for the selector 7.

When the branch condition storage unit 1 includes condition storage units 101 to 104 in this exemplary embodiment, the control circuit 6g may cause the one condition comparison unit 51 to sequentially make determinations as to whether branch conditions respectively set in the four condition storage units 101 to 104 hold or not, and then may output the selection control signal to the selector 7. Alternatively, in a stage where one of the branch conditions respectively set in the four condition storage units 101 to 104 selected according to the priority order has held, the control circuit 6g may output the selection control signal (T) to the selector 7 without performing determinations as to whether or not the remainder of the conditions holds by the condition comparison unit 51.

In this exemplary embodiment as well, a mask bit may be provided at the operand of the conditional branch instruction (XBRA), as in the exemplary embodiment described above, and the branch condition storage unit 1 may set only branch conditions stored in selected ones of the condition storage units 101 to 104 to be valid. In this case, a configuration may be employed where AND operation results of respective bits of the mask bit of the operand of the conditional branch instruction (XBRA) decoded by the instruction decoder 2 and respective outputs of the four latch circuits not shown in the control circuit 6g are supplied to the OR (OR) circuit in the control circuit 6g. In this configuration, when the output of the logical OR (OR) circuit indicates 0, and the overflow of the counter 6g does not occur, the count clock for incrementing (or decrementing) the counter 6f by 1 is output. Then, in a stage where the output of the OR circuit has indicated 1, the control circuit 6g determines branch establishment, and supplies the selection control signal T(1) of the selector 7.

In this exemplary embodiment, the number of execution cycles of the conditional branch instruction increases corresponding to just the number of branch conditions, so that an execution speed is reduced more than in the first exemplary embodiment. However, configurations of the condition comparison unit 5 and the conditional branch determination unit 6 are simplified. Thus, there is an advantage that the circuit size can be reduced.

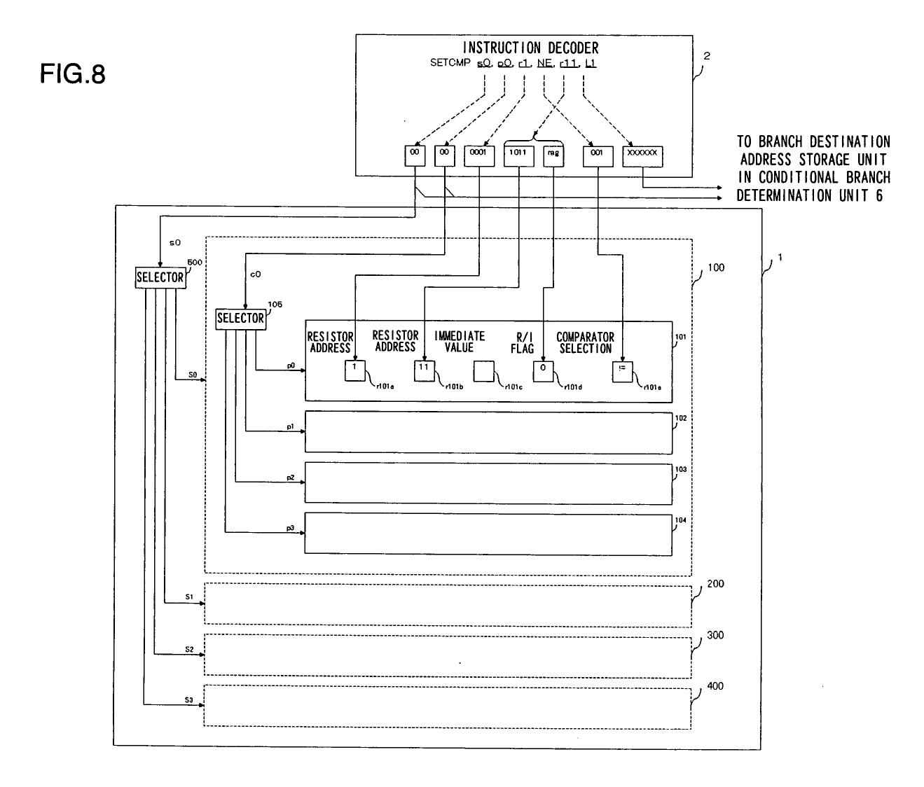

FIG. 8 is a diagram showing a still another configuration of the exemplary embodiment in the present invention. When the number of branch conditions capable of being stored in the branch condition storage unit 1 is increased, the number of branch conditions capable of being selected by the selector 105 may be simply increased. Alternatively, as shown in FIG. 8, another selector 500 may be provided to allow hierarchically select the branch conditions.

Referring to FIG. 8, the branch condition storage unit 1 includes condition storage units 100, 200, 300, and 400 and the selector 500 that selects which one of the condition storage units 100 to 400 is valid.

The condition storage unit 100 includes the condition storage units 101, 102, 103, and 104, and the selector 105 that selects which one of the condition storage units 101, 102, 103, and 104 is valid. Incidentally, though internal configurations of the condition storage units 200, 300, and 400 are not illustrated for simplification, each of these condition storage units has the same configuration as the condition storage unit 100.

In the condition storage unit 101, reference numeral r101a denotes a register that stores therein a first register address of an operation register 4, reference numeral r101b denotes a register that stores a second register address of the operation register 4, reference numeral r101c denotes a register that stores immediate value data, reference numeral r101d denotes a register that stores therein an R/I flag (R=register, which denotes a register address, I=immediate, which denotes an immediate value), and reference numeral r101e denotes a register that stores therein an operation type of a comparison operation element.

In this exemplary embodiment, it is arranged that one of values “p0” to “p3” for selecting one of the condition storage units 100 to 400 can be specified at the operand of the condition setting instruction (SETCMP), for example. It is further arranged that similar specification can be made in the conditional branch instruction.

### (Example of Condition Setting Instruction)

SETCMP s0, p0, r1, NE, r11, L1 (4)

The condition storage unit 100 is selected by “s0”. The condition storage unit 101 in the condition storage unit 100 is selected by “p0”. Likewise, the condition storage units 200, 300, and 400 are selected by “s1”, “s2”, “s3”, respectively.

In this exemplary embodiment, in a conditional branch instruction indicated by:

XBRA s0 (5)

a series of branch conditions in the condition storage unit 100 are selected by “s0”.

Referring to FIG. 8, when the conditional branch instruction (XBRA s0) is executed, a signal s0 from the instruction decoder 2 is supplied to the selector 500, so that the condition storage unit 100 is selected. In the case of a conditional branch instruction (XBRA si), the selector 500 selects the condition storage unit 200. Likewise, the condition storage units 300 and 400 are selected by “s2” and “s3”, respectively.

With the configuration as described above, the series of branch conditions that have been formed can be stored in the condition storage units 101 to 104. Especially when this exemplary embodiment is applied to multiplex loop processing, the processing can be performed without setting the series of branch conditions again. Thus, a higher speed of conditional branch processing can be achieved.

### Third Exemplary Embodiment

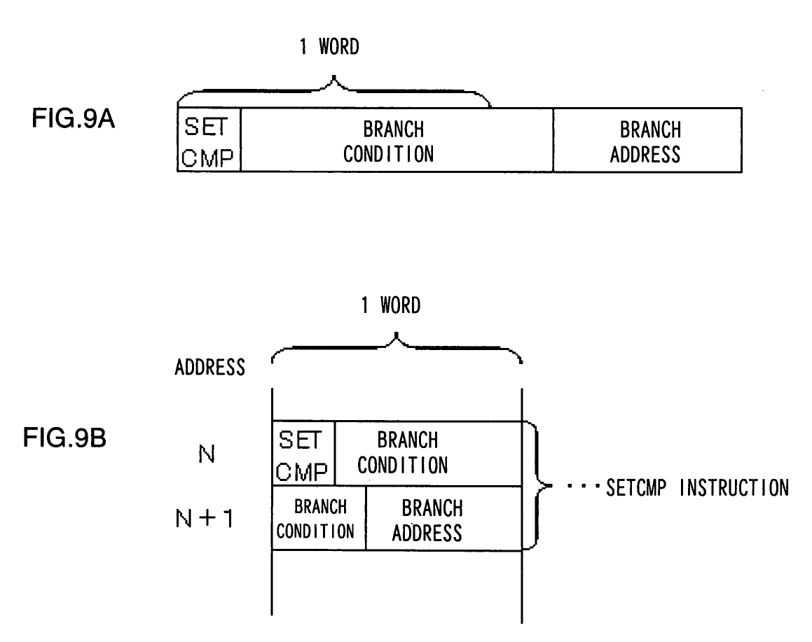

FIGS. 9A and 9B are diagrams for explaining another exemplary embodiment of the present invention. In the first exemplary embodiment, as the instruction length of the condition setting instruction (SETCMP), one word suffices (refer to FIG. 6).

When information on a branch condition to be specified is increased as in the condition setting instruction in the exemplary embodiment shown in FIG. 8, the instruction length of the condition setting instruction is increased, and may not be accommodated in one word of the instruction memory, as shown in FIG. 9A. In the example shown in FIG. 9A, an op code and a portion of a branch condition constitute one word.

In this exemplary embodiment, the instruction length of a condition setting instruction (SETCMP) may extend over two words or more, as shown in FIG. 9B. In this case, two steps or more corresponding to the instruction length of two words or more, for example, are necessary for execution of the condition setting instruction. However, the execution cycle of a conditional branch instruction (XBRA) remains to be one step, in this exemplary embodiment. For this reason, the execution time taken for branch processing remains unchanged, so that the processing can be performed without reducing the speed of the execution. This is very effective in that the execution speed of conditional branching is not reduced in loop processing in particular where the same condition is repeatedly executed.

Assume the similar case in Patent Document 1. When the instruction length of a condition determination instruction is two words and two steps are needed for execution of the instruction, 2×4=8 steps are needed for processing four branch conditions. Further, one step for a multi-branch instruction is added. Then, a total of 9 steps are needed for each of the number of repetition of the loop processing.

(2×4+1)×the number of loops (6)

On contrast therewith, in this exemplary embodiment, the condition setting instruction is executed outside the loop processing. Thus, even if two steps are taken for execution of the condition setting instruction, just the number of steps needed for execution of the conditional branch instruction is needed as the number of branch processing steps for the loop processing.

2×4+1×the number of loops (7)

When the address space of the instruction memory is increased, the number of bits of a branch destination address specified by the condition setting instruction is increased. In this case as well, the instruction length of the condition setting instruction is increased, so that may not be accommodated in one word.

When a plurality of branch destination addresses are specified by a conditional branch instruction as in Patent Document 2, the instruction length of the conditional branch instruction is extremely increased, and the number of steps of execution of the instruction will be correspondingly increased.

In case the instruction length of the conditional branch instruction is four words because of inclusion of four branch destination addresses, for example, four steps are needed for one execution of the conditional branch instruction. Thus, the number of branch processing steps needed for loop processing is as follows:

4×the number of loops (8)

On contrast therewith, in this exemplary embodiment, a conditional branch instruction does not include a branch destination address. Thus, one word suffices as the instruction length of the conditional branch instruction, and the processing time corresponding to just one step is needed for execution of the conditional branch instruction. Thus, the number of branch processing steps needed for the loop processing is as follows:

1×the number of loops (9)

### Fourth Exemplary Embodiment

Next, still another exemplary embodiment of the present invention will be described. Priority orders of the priority encoder 6b in FIG. 5 may be opposite to the priority orders shown in Table 2.

According to this exemplary embodiment, a priority order can be specified in a condition setting instruction (SETCMP). Thus, the logic of a priority encoder 6b may be such that the priority orders set in the priority encoder 6b are opposite to the priority orders shown in Table 2. A truth-value table when the priority orders are opposite to those of the priority orders in Table 2 will be shown below.

TABLE 3
An Example of Truth-value Table of Priority Encoder

| c3 | c2 | c1 | c0 | b1 | b0 |
|---|---|---|---|---|---|
| 0 | 0 | 0 | 0 | 0 | 0 |
| 0 | 0 | 0 | 1 | 0 | 0 |
| 0 | 0 | 1 | 0 | 0 | 1 |
| 0 | 0 | 1 | 1 | 0 | 1 |
| 0 | 1 | 0 | 0 | 1 | 0 |
| 0 | 1 | 0 | 1 | 1 | 0 |
| 0 | 1 | 1 | 0 | 1 | 0 |
| 0 | 1 | 1 | 1 | 1 | 0 |
| 1 | 0 | 0 | 0 | 1 | 1 |
| 1 | 0 | 0 | 1 | 1 | 1 |
| 1 | 0 | 1 | 0 | 1 | 1 |
| 1 | 0 | 1 | 1 | 1 | 1 |
| 1 | 1 | 0 | 0 | 1 | 1 |
| 1 | 1 | 0 | 1 | 1 | 1 |
| 1 | 1 | 1 | 0 | 1 | 1 |
| 1 | 1 | 1 | 1 | 1 | 1 |

In the priority encoder 6b in FIG. 4 or 5, the priority order is reduced in the order of comparison operation results c3, c2, c1, and c0 (or the priority order is increased in the order of the comparison operation results c0, c1, c2, and c3). That is, when the comparison operation result c3 is 1 and when at least one of the comparison operation results c2 to c0 is 1 at the same time, the priority encoder 6b selects the comparison operation result c3 and outputs an output 11b. When the comparison operation result c3 is 0 and the comparison operation result c2 is 1, and when at least one of the comparison operation results c1 and c0 is 1 at the same time, the priority encoder 6b selects the comparison operation result c2, and outputs an output 10b. When the comparison operation results c3 and c2 are 0 and the comparison operation result c1 is 1, and when the comparison operation result c0 is 1 at the same time, the priority encoder 6b selects the comparison operation result c1, and outputs an output 01b. When the comparison operation results C3, C2, and C1 are 0, and the comparison result c0 is 1, the priority encoder 6b selects the comparison operation result c0, and outputs an output 00b. When one ci (in which i is one of 0 to 3) of the comparison operation results c0, c1, c2, and c3 is 1, and the other comparison operation results are 0, the priority encoder 6b outputs a two-bit code corresponding to i of the comparison operation result ci. The priority encoder 6b controls selection of a selector 6d so that one branch destination address with the comparison operation result of 1 is selected.

In this exemplary embodiment, two types of priority encoders that use prioritization methods where priority orders are set in an ascending order and a descending order may be provided. Then, according to specification in a conditional branch instruction, switching between the priority encoders may be performed, or one of the priority encoders may be selected. In this case, specification for switching of the ascending order and the descending order may be performed using one bit. The bit which specifies the ascending or descending order (the ascending order being specified when the bit is 0, while the descending order being specified when the bit is 1) may be added to the op code or operand of the conditional branch instruction.

Conditional branch processing is performed by a combination of two instructions. In this processing, immediately after a comparison or operation instruction, it is ensured that the flag of the result of the operation is held in a flag register, and in response to a next branch instruction, the flag is evaluated, thereby executing the branch processing. On contrast therewith, in the present invention, by setting a branch condition in advance using the condition setting instruction, only the processing time for one conditional branch instruction is needed in a state where the conditional branch processing is performed. Thus, the branch processing can be performed at a higher speed. By applying this exemplary embodiment to loop processing where the same condition is repeatedly executed, further higher-speed loop processing can be achieved.

A condition setting storage unit and a branch destination address storage unit which can store information on a plurality of branch conditions and a plurality of branch destination addresses are provided. Prioritization is performed in advance using the condition setting instruction, and then the information on those items is stored. Then, a condition comparison unit that reads a series of branch conditions from the condition setting storage unit, and performs comparison operations is provided. A conditional branch determination unit capable of selecting a branch destination address corresponding to one of the branch conditions that has held based on an output result of the condition comparison unit is provided. The processing for conditional branching described above can be executed using one conditional branch instruction. Even if a plurality of branch conditions simultaneously hold, the conditional branch determination unit selects the branch address corresponding to the branch condition having the highest priority order.

By including the condition setting storage unit, the plurality of branch conditions can be stored. Thus, this exemplary embodiment can be applied to a combination of more complicated conditions and multiplex loop processing. Thus, further higher-speed processing can be achieved.

With respect of an increase in the length of an instruction caused by an increase in information on a branch condition and a branch destination address as well, the instruction length of the conditional branch instruction is scarcely affected because these information is set in advance by the condition setting instruction to be executed. For this reason, even when the present invention is not utilized and a reduction in an execution speed due to an increase in the instruction length occurs, high-speed processing can be performed according to the present invention, without increasing the number of execution steps at a time of branch processing and without reducing the execution speed of the conditional branch instruction at a time of the loop processing in particular.

An operation and effect difference between the exemplary embodiment described above and the above-described related arts will be described by contrasting the exemplary embodiment described above and the related arts.

In Patent Document 1, execution of a branch condition determination instruction the number of times needed for branch conditions is necessary immediately before execution of a conditional branch instruction. Thus, even in loop processing where the same branch condition is repeatedly executed, execution of a series of branch condition determination instructions for the branch condition is needed. According to this exemplary embodiment, a branch condition that has been set once is held as long as setting of the branch condition is changed again. Thus, it is not necessary to execute the condition setting instruction again. Thus, branch processing can be processed only by execution of the conditional branch instruction. Accordingly, the branch processing can be performed at higher speed.

In Patent Document 2, a branch determination is made based on an operation result immediately before a branch instruction, as in Patent Document 1. Further, only the operation result of one instruction immediately before the branch condition is given. Accordingly, compared with Patent Document 1 and the present invention, only a very simple branch condition can be accommodated. However, only one step for the conditional branch instruction is needed. Thus, the speed of branch processing in Patent Document 2 is the same as in the first exemplary embodiment (in FIG. 1) of the present invention.

In a second exemplary embodiment of Patent Document 2, when the value of a branch destination address is to be increased, the instruction length of a conditional branch instruction is increased due to inclusion of a plurality of branch destination addresses. This shows that the instruction length extends over 2 words of an instruction memory. In this case, a step for reading a value in the second word into an instruction decoder is generated. Thus, generally, the number of instruction execution cycles is correspondingly increased. On contrast therewith, in the present invention, no branch destination address is included in the conditional branch instruction, as described in the exemplary embodiment described above. Thus, the problem as described above does not arise. When the value of a branch destination address is to be increased in the present invention, the instruction length of the condition setting instruction is just increased, and branch processing itself is not slowed down.

In a digital signal processor described in Patent Document 3, a condition determination is made with the result of a calculation instruction (described in the claim in Patent Document 3 to be selected as one of an output from a calculation unit, an output from a logical shifter, and an output from a multiplier) used for comparison. Thus, only a simple branch condition can be set.

Each disclosure of Patent Documents 1 through 4 described above is incorporated herein by reference. Modifications and adjustments of exemplary embodiments are possible within the scope of the overall disclosure (including claims) of the present invention, and further based on the basic technical concept of the invention. Various combinations and selections of various disclosed elements are possible within the scope of the claims of the present invention. That is, the present invention of course includes various variations and modifications that could be made by those skilled in the art according to the overall disclosure including the claims and the technical concept.

What is claimed is:

1. A processor apparatus comprising:
an instruction set that includes a condition setting instruction that specifies a branch condition and a priority order of the branch condition;
an instruction decoder that decodes an instruction; and
a branch condition storage unit that includes a plurality of storage regions, each of which stores therein a branch condition set by the condition setting instruction,
in response to decoding of the condition setting instruction by the instruction decoder, the branch condition storage unit storing the branch condition specified by the condition setting instruction in one of the storage regions corresponding to the priority order specified by the condition setting instruction.

2. The processor apparatus according to claim 1, comprising:
a branch destination address storage unit being capable of storing therein a plurality of branch destination addresses each for branching when a branch condition holds,
the condition setting instruction, specifying in addition to the branch condition and the priority order of the branch condition, a branch destination address to which branching is performed when the branch condition specified by the condition setting instruction holds,
in response to decoding of the condition setting instruction by the instruction decoder, the branch destination address storage unit storing the branch destination address specified by the condition setting instruction in association with the priority order specified by the condition setting instruction.

3. The processor apparatus according to claim 1, wherein the instruction set includes a conditional branch instruction, whereby a determination on the branch condition is made and branching to the branch destination address is performed when the branch condition holds, and wherein the processor apparatus further comprises:
a branch condition comparison unit including one or a plurality of condition comparison units that make respective determinations on one or a plurality of branch conditions stored in the branch condition storage unit, when the conditional branch instruction is executed, with the one or the plurality of branch conditions being stored in the branch condition storage unit and one or a plurality of branch destination addresses being stored in the branch destination address storage unit, after one or a plurality of the condition setting instructions have been executed; and
a conditional branch determination unit that selects from the branch destination address storage unit the branch destination address corresponding to the branch condition stored in a predetermined one of the storage regions of the branch condition storage unit according to a prioritization method set in advance, when there are a plurality of comparison operation results of the plurality of the condition comparison units indicating that a plurality of the branch conditions simultaneously hold,
branching being performed to the branch destination address selected by the conditional branch determination unit.

4. The processor apparatus according to claim 3, wherein the conditional branch determination unit selects from the branch destination address storage unit the branch destination address corresponding to the branch condition stored in one of the storage regions of the branch condition storage unit with a highest priority order among the branch conditions that simultaneously hold, and the branching is performed to the branch address.

5. The processor apparatus according to claim 3, wherein when one branch condition holds, the condition determination unit selects the branch destination address corresponding to the one branch condition and branching is performed to the branch address, and
when no branch condition holds, the condition determination unit outputs information indicating that no branch condition holds, branching is not performed, and a program counter is incremented by one.

6. The processor apparatus according to claim 1, wherein the branch condition stored in each of the storage regions of the branch condition storage unit includes:
first and second register addresses of first and second operation registers targeted for comparison;
an immediate value data;
a flag that stores a type of a comparison operation between data in the operation registers or a comparison operation between data in one of the operation registers and the immediate value data; and
a type of a comparator operation.

7. The processor apparatus according claim 1, wherein the condition setting instruction has an operand including:
an information that functions as priority order information and specifies one of the storage regions of the branch conditions in the branch condition storage unit;
a type of comparison operation;
a first register address of an operation register and a second register address of the operation register targeted for the comparison operation or an immediate value data; and
a branch destination address.

8. The processor apparatus according to claim 1, wherein the branch condition storage unit includes:
a plurality of condition storage units as the plurality of storage regions; and
a selector that selects one of the condition storage units that stores therein the branch condition specified by the condition setting instruction based on the priority order information on the branch condition specified by the condition setting instruction decoded by the instruction decoder.

9. The processor apparatus according to claim 1, comprising:
a plurality of the branch condition storage units; and
another selector that selects one of the branch condition storage units.

10. The processor apparatus according to claim 9, wherein the condition setting instruction has an operand including:
a first information that specifies the one of the branch condition storage units;
a second information that functions as the priority order information and specifies the one of the storage regions of the branch conditions in the branch condition storage unit;
a type of comparison operation;
a first register address of an operation register and a second register address of the operation register targeted for the comparison operation or an immediate value data; and
a branch destination address.

11. The processor apparatus according to claim 10, wherein the conditional branch instruction has the operand including an information specifying one of the branch condition storage units.

12. The processor apparatus according to claim 3, wherein the conditional branch instruction has an operand including a mask bit field specifying whether to not to specify masking of comparison operation results in the condition comparison units.

13. The processor apparatus according to claim 1, wherein the branch condition storage unit comprises:
a plurality of condition storage units each of which stores therein the condition comprising:
first and second register addresses of the two operation registers targeted for comparison;
an immediate value data;
a flag that stores the type of the comparison operation between data in the operation registers or the comparison operation between data in the one of the operation registers and the immediate value data; and
a type of comparator operation, as one set;
the plurality of condition storage units constituting the plurality of storage regions that store therein the branch conditions, respectively,
the processor apparatus comprising a selector that selects one of the condition storage units.

14. The processor apparatus according to claim 13, wherein the branch condition comparison unit includes sets of the condition comparison units, each set including:
first and second decoders that respectively decode the first and second register addresses stored in a corresponding one of the condition storage units, respectively output the first and second register addresses to the operation registers, and respectively hold data read from the operation registers;
a third selector that receives the immediate data stored in the corresponding one of the condition storage units and a value of the second decoder, and selects one of the immediate data and the value of the second decoder based on an output of the flag; and
a comparator that receives an output of the third selector and an output of the first decoder as inputs and performs an operation corresponding to the operation type stored in the complex condition storage unit;
the sets of the condition comparison units being provided corresponding to the condition storage units, respectively.

15. The processor apparatus according to claim 3, wherein the conditional branch determination unit comprises:
a second selector that stores the branch destination address specified by the condition setting instruction in a corresponding storage region of the branch destination address storage unit based on the priority order specified by the condition setting instruction decoded by the instruction decoder;
a priority encoder that receives the comparison operation results from the condition comparison units, outputs a signal that selects one branch destination address according to the prioritization method set in advance when the plurality of the comparison operation results indicate that the plurality of the branch conditions hold, and outputs a signal that selects the branch destination address corresponding to one branch condition when the one branch condition holds;
a third selector that selects the branch destination address selected by the priority encoder from among the plurality of branch destination addresses stored in the branch destination address storage unit;
a logic circuit that outputs a first value when all of the comparison operation results from the condition comparison units indicate that no branch condition holds, and outputs a second value for the other combinations of the comparison operation results from the condition comparison units; and
a fourth selector that receives an output of a program counter and an output of the third selector, and sets the output of the program counter or the output of the third selector in the program counter according to whether an output of the logic circuit assumes the first value or the second value.

16. The processor apparatus according to claim 15, wherein logic operation results of a mask bit specified by the conditional branch instruction and the comparison operation results from the condition comparison units are supplied to the priority encoder.

17. The processor apparatus according to claim 3, wherein the conditional branch determination unit comprises:
a second selector that stores the branch destination address in a corresponding storage region of the branch destination address storage unit based on information specifying the storage region of the branch condition and the branch destination address specified by the condition setting instruction decoded by the instruction decoder;
a counter that selects one of the branch destination addresses in the branch address storage unit and one of the branch conditions in the branch condition storage unit, using a count value output from the counter;
a third selector that selects the branch destination address selected by the counter from among the branch destination addresses stored in the branch destination address storage unit; and
a fourth selector that receives an output of a program counter and an output of the third selector and sets the output of the program counter or the output of the third selector according to whether an output of the condition comparison units indicates branch condition establishment or not,
condition comparison of the branch condition selected according to the count output of the counter being executed.

18. A processor apparatus comprising:
an instruction set that includes:
a condition setting instruction that sets a branch condition and a branch destination address to which branching is performed in case the branch condition holds, in association with a specified priority order; and
a conditional branch instruction that determines whether or not at least one branch condition set by the branch condition setting instruction holds, and causes branching to a corresponding one of branch destination addresses when the at least one branch condition holds;
a branch condition storage unit that stores therein one or a plurality of branch conditions specified by one or a plurality of the condition setting instructions corresponding to priority orders specified by the condition setting instructions, respectively;
a branch destination address storage unit that stores one or a plurality of branch destination addresses specified by the one or the plurality of the condition setting instructions, in association with the priority orders specified by the condition setting instructions, respectively; and
a circuit unit that selects from the branch destination address storage unit the branch destination address corresponding to the branch condition stored in a predetermined storage region of the branch condition storage unit according to a prioritization method set in advance, when individual determinations on the one or the plurality of branch conditions already stored in the branch condition storage unit are made and a plurality of the branch conditions simultaneously hold at a time of execution of the conditional branch instruction, wherein in a state where the one or the plurality of branch conditions have been set in the branch condition storage unit and the one or the plurality of branch destination addresses have been stored in the branch destination address storage unit by execution of the one or the plurality of the condition setting instructions, at least one other instruction being allowed to be executed during execution of the conditional branch instruction after execution of the one or the plurality of the condition setting instructions.

19. A method of processing a conditional branch in a processor, comprising:
decoding a conditional setting instruction;
storing a branch condition specified by the condition setting instruction in a branch condition storage unit in association with a priority order specified by the condition setting instruction; and
storing a branch destination address specified by the condition setting instruction in a branch condition storage unit in association with the priority order.

20. The method according to claim 19, further comprising:
when a conditional branch instruction is executed, after one or a plurality of the condition setting instructions have been executed and then one or a plurality of branch conditions and branch destination addresses have been stored,
making respective determinations on one or a plurality of the stored branch conditions; and
when a plurality of the branch conditions holds, branching to the branch destination address corresponding to the branch condition selected according to a prioritization method set in advance.
